(19) United States
(12) Patent Application Publication
(10) Pub. No.: US 2023/0412993 A1
(43) Pub. Date: Dec. 21, 2023

(54) SYSTEM AND DEVICE FOR INFORMING ABOUT SPATIALLY DISTRIBUTED OBJECTS

(71) Applicants: Jana KALBERMATTER, Basel (CH); Louis Daniel MOSER, Allschwil (CH)

(72) Inventors: Jana KALBERMATTER, Basel (CH); Louis Daniel MOSER, Allschwil (CH)

(21) Appl. No.: 18/253,335

(22) PCT Filed: Nov. 18, 2021
(86) PCT No.: PCT/EP2021/082092

§ 371 Date: May 17, 2023

(30) Foreign Application Priority Data
Nov. 18, 2020 (CH) 01470/20

(51) Int. Cl. H04R 25/00; G06K 7/10; H04R 1/10

(52) U.S. Cl. CPC H04R 25/606; G06K 7/10306; H04R 1/1041; H04R 2460/13

(57) ABSTRACT

The present invention relates to a portable device (1) for providing a user with audio information about spatially distributed objects (50), comprises: a bone conduction generator having an electromechanical transducer to convert electrical signals to mechanical vibrations, an identification receiver (24) configured to receive an identification identifying one of the objects, and a controller (25) connected to the bone conduction generator and to the identification receiver (24), wherein the controller (25) is configured to obtain the identification received by the identification receiver (24) and to provide electrical signals to the bone conduction generator such that the bone conduction generator provides mechanical vibrations to generate sound waves representing the audio information about the one of the objects (59) identified by the obtained identification signal. The present invention also relates to a system for providing a user with audio information about spatially distributed objects (50), comprising at least one portable device as described above, and a plurality of identifiers each configured to be associated to one of the objects (50) and to send an identification signal identifying the one of the objects.

### TECHNICAL FIELD

The present invention relates to a portable device and a system for providing a user with audio information as well as digital service about spatially distributed objects.

Such device and system can be used in a museum, at an exhibition, a trade fair, a retail store or the like, where usually a large number of objects are presented. Each of the objects may be associated with information that describes or tells a story relating to the object.

### BACKGROUND ART

When visiting museums, historical sites and other scenic spots, especially when viewing exhibits with a strong historical and/or cultural background, visitors often would like to have background knowledge of the exhibits. At present, there are mainly the following ways for visitors to learn about exhibits.

Method 1: Understand the relevant knowledge of the exhibits through human explanation such as by a professional tour guide. Sometimes, the human explanation is not very detailed for some exhibits, and visitors need to follow the tour guide, otherwise relevant explanations may be missed, which reduces the freedom of visitors to visit. Furthermore, the tour guide walks through the exhibits, and the exhibition explanation time is short. The explanation is usually focused on important exhibits since the professional tour guide involves high operation costs.

Method 2: Learn about the relevant knowledge of the exhibits by viewing the relevant text introduction of the exhibits in the exhibition area. A text introduction board is set up next to the exhibits, but the text introduction is limited in space, unable to display all the information of the exhibits, and the text introduction is not intuitive and cannot meet all the needs of the visitors.

Method 3: Learn about the relevant knowledge of the exhibits through the automatic explanation equipment provided in an exhibition area. Some exhibition areas will provide automatic explanation equipment such as a headphone. When such automatic explanation equipment is brought into the explanation area of the corresponding exhibit, the automatic explanation equipment can receive corresponding exhibit information, and provide relative exhibit explanations to the visitors. This method is the most common exhibit display method in existing scenic spots and museums, but this method needs to be provided to tourists with a guiding device or headset, which is often lost or damaged, thereby involving high maintenance cost. Furthermore, the headphones isolate the visitors such that they lose concentration or focus to the environment.

Method 4: Scanning a QR code to navigate with a smartphone App. With the development of modern mobile communication technology, smart mobile communication equipment has basically become an indispensable communication tool for people, and some App has also become an indispensable software for smart mobile communication equipment. Therefore, some scenic spots and museums will make exhibit information into a QR code. When a visitor needs to know the exhibit information about an object, he can scan the QR code corresponding to the exhibit to pop up the exhibit information, but this scanning method is more cumbersome. Each exhibit corresponds to a different QR code, and the visitor needs to scan the QR code every time when he is interested in an object, thereby causing inconvenience to visitors. Furthermore, the visitors have to gather the information from smart mobile communication equipment such that they lose focus to the exhibits and the scene around the exhibits.

In summary, in order to meet the needs of visitors and increase the user experience, museums, exhibitions and scenic spots have a need to provide a system that can automatically provide exhibits explanations based on the need and the location of the visitors.

### DISCLOSURE OF THE INVENTION

According to the invention this need is settled by a portable device as it is defined by the features of independent claim 1, and by a system as it is defined by the features of independent claim 22. Preferred embodiments are subject of the dependent claims.

In particular, in one aspect the invention is a portable device for providing a user with audio information about spatially distributed objects, comprises: a bone conduction generator having an electromechanical transducer to convert electrical signals to mechanical vibrations, an identification receiver configured to receive an identification signal identifying one of the objects, and a controller connected to the bone conduction generator and to the identification receiver. According to the present invention, the controller is configured to obtain the identification signal received by the identification receiver and to provide electrical signals to the bone conduction generator such that the bone conduction generator provides mechanical vibrations representing the audio information about the one of the objects identified by the obtained identification signal.

The term “bone conduction” as used herein relates to the conduction of sound to the inner ear primarily through the bones of the skull and/or through cartilage tissue of the head. The use of bone conduction particularly allows the hearer or user to perceive audio information without blocking the ear canal.

In this connection, the portable device preferably is arranged to contact a head of a user in order to transfer the audio information about the one of the objects by means of the sound waves generated by the mechanical vibrations provided by the bone conduction generator, wherein the portable device is shaped to keep an ear canal of the user free while contacting the head of the user.

In order to efficiently work, the bone conduction generator advantageously is embodied to generate as comparably much vibration and at the same time comparably few airborne sound. For achieving this, bone conduction generators are typically structurally different form conventional loudspeakers or similar airborne sound generators. For example, the used electromechanical transducers usually provide comparably high vibration forces as stronger vibration are required to induce bone conduction compared to air conduction.

In a preferred embodiment, at least the electromechanical transducer is surrounded by an airborne sound absorbing material. Such airborne sound absorbing material allows for reducing airborne sound generation and helps to improve the ratio between generation of vibration compared to airborne sound produced by the bone conduction generator. Particularly, the electromechanical transducer can be completely encased by the sound absorbing material. In an efficient embodiment, the complete bone conduction generator is surrounded by the sound absorbing material. The sound absorbing material can be, e.g., a thermoplastic member or a silicone member or any other member considerably reducing the provision of airborne sound.

Preferably, the identification receiver configured to receive the identification signal from an identifier associated to the one of the objects when the identification receiver is within a reach of the identifier. The reach of the identifier can vary based on the signal strength and technology used by the identifier.

The mechanical vibrations generated by the bone conduction generator can be conducted to an inner ear of a human via the bones of the skull, which allows the user to perceive audio content without blocking the ear canal. In comparison with play back of audio information by conventional devices such as headsets, this portable device according to the present invention provides improved user experience and convenience as well as hygiene, in particular, in case of often removing and attaching of the device from and into the ear of the user. Furthermore, using the bone conduction generator the user can still hear the sound from the surrounding place since the ear canal is not blocked, i.e. both ears remain free. This enables the user to listen to the audio information provided by the portable device and at the same time when he talks with person around him.

The term “audio information” in connection with the spatially distributed objects may comprise a description relating to each of the objects. The audio information may be digitally stored in a non-volatile memory that is arranged in the portable device or in a host connected with the portable device. The description may include a set of characteristics in digital audio form expressed in words of any languages like an audio book, a melody or any kind of music. That is the audio information may be a digital audio representation of the description or story about one or more objects. The bone conduction generator can convert the digital audio information into electric signals and generates the mechanical vibration. The vibration can be transmitted through the skull bones to the ear as sound wave so that the user can perceive the play back of the digital audio information.

The identification signal can represent an identification of the object, e.g. name of the object, short description of the object or related content, or simply a serial number associated with the object. It can also represent the position or location of the object.

The term “identifier” may relate to a relative position of the portable device to an object. For example, such relative position may be a distance to the object. The relative position can be determined using triangulation technology. For instance, when determining the actual position of the portable device, e.g. by triangulation via a suitable infrastructure, and the portable device moves close to an object having a known position, the identifier can correspond to a calculated or determined distance between the portable device and the object. More specifically, when said distance is small enough the portable device can receive an identification of the object connected with the portable device.

However, advantageously the term “identifier” relates to an electronic identifier or sender associated with the object. The identifier can be arranged next to the object, in an empty space within the object, or it can be mounted to the object. The identifier provides the identification of the object to the identification receiver of the portable device when the portable device occurs or appears nearby the identifier, in particular, when the portable device is within the signal reach of the identifier. Preferably, the identifier is an electronic device that can store and send the identification of the object in digital form to the identification receiver. If the user carrying the portable device walks close to an object, i.e. within the signal reach of the identifier, identification receiver of the portable device receives the identification signal from the electronic identifier. Upon receiving the identification signal, the portable device notifies the user that the audio information about the object is available. The user can place the portable device at the skull and/or cartilage around, behind or advantageously in front of the ear and the audio representation of the information relating to the object can automatically be played back or upon pressing a play button. This automatic identification of the object enables an improved and simplified user experience since there is no need to manually enter the identification of the object.

Alternatively, a relative position of the portable device to an object can be determined using the triangulation technology. For instance, when the portable device moves close to an object, it can receive an identification of the object from any devices that are wirelessly connected with the portable device. In this case there is no need to arrange an identifier close to echo of the objects for sending the identification signal.

The term “connected” in context of the controller, the bone conduction generator and the identification receiver can relate to a communication connection. In particular, the controller can be connected to the bone conductions generator and the identification receiver to transmit and/or receive communication signals. Thus, communication channels can be established between the controller, the bone conduction generator and the identification receiver.

The term “obtain” in connection with signals and information may generally relate to an active gathering of a signal or information (pull), to a passive receiving of the signal or information (push), or of a combination thereof.

The term “receive” in connection with signals and information may generally relate to get the signals and information. The signals and the audio information can be sent in an electronic broadcast, multicast or unicast message. Alternatively, the receiver can actively ping the sender, e.g. the identifier, and obtains the signals or information upon responding by the sender.

Preferably, the identification signal represents or comprises a position of the one of the objects. In this connection, the position can be any characteristic or feature of the identification signal allowing to provide information about the position. The position advantageously is a relative position such as, particularly, a distance or proximity of the portable device to a sender, or indicates that the portable device is in a field of activity of the sender. By including or representing a position of the one of the objects in or by the identification signal an efficient evaluation or selection of the appropriate audio information to be provided can be achieved.

For example, in embodiments where the position represents a proximity between the portable device and the objects, the position can be a signal strength of the identification signal. More specifically, the controller can be configured to evaluate the signal strength of the received identification signals and select or identify to closest object being the object having the highest signal strength. Also, the controller can be configured to only provide the mechanical vibrations once proximity, e.g. signal strength, is sufficiently high.

Thus, the position preferably comprises a proximity between the portable device and the one of the objects. Such proximity allows for efficiently determining the position of the portable device relative to the one of the objects. In particular, using the proximity as position allows for simply acquiring sufficient information for appropriate provision of audio information related to the relevant object. Moreover, it can be prevented that comparably complicated positioning eventually including location and orientation of the portable device is involved. Rather, such configuration allows for simply identifying when one of the objects is close enough such that providing audio information about that object is appropriate. In other words, the position including proximity can be used for reliably identifying an object being the closest object to the portable device and to provide the audio information associated to the identified object. This simplifies the management of the information associated to the objects, the evaluation of the position and the setup of the portable device.

Thus, the controller preferably is configured to evaluate the position of the identification signal to determine proximity between the portable device and the one of the objects. In an environment comprising a plurality of objects equipped with senders accessing the portal device, such evaluation of proximity the objects allows to efficiently identify the closest or otherwise most appropriate of the objects and to provide the relevant audio information associated to the identified object. Thus, the controller preferably is configured to provide the electrical signals to the bone conduction generator in accordance with the determined proximity.

Determination of the position can be based on any suitable communication technologies such as, specifically, ultra-wideband.

Preferably, the identification receiver comprises an ultra-wideband sensor or receiver to receive ultra-wideband signals. In a preferred embodiment, the identification signal is an ultra-wideband signal sent by the identifier. The ultra-wideband technology is particularly advantageous for the short-range communication, since it allows low energy consumption and at the same time provides a high-bandwidth over a large portion of the radio spectrum. Also, ultra-wideband technology allows for a comparably accurate provision of the position or proximity.

The identifier can be in form of an ultra-wideband sender that allows communication with the portable device and provides identification information and location or position information of the object to the portable device. Alternatively, for communicating with the identifier, the identification receiver can be equipped with a suitable adapter such as a wireless local area network (WLAN) adapter, a Bluetooth adapter, a near filed communication (NFC) adapter or the like. In the latter case, the user needs to place the portable device close to the identifier, which is still more convenient than entering the code or scanning any QR code to identify the object.

The reach or signal reach of the identifier can vary according to the need, e.g. about up to 50 meters for a large object, 10 to 20 meters for a medium object and less than 1 to 5 meters for a small object. When the portable device is within the reach of the ultra-wideband signal, it receives the identification signal, e.g. as a broadcast message, from the identifier. For instance, a user with the portable device approaches to a painting in a museum room and the portable device will receive the identification signal of the painting when the user is about 3 meters away from the painting. Upon receiving the identification signal the portable device can send a notification or readiness signal to the user.

The term “readiness signal” in connection with the identification signal can also be seen as a notification signal, i.e. a signal notifies the user when the identification signal of an object has been received and the audio information about this object is ready for play back.

Preferably, the portable device comprises a housing encasing the bone conduction generator, the identification receiver and the controller, wherein at least a part of the housing encasing the bone conduction generator forms an essentially completely tight outer surface. In other words, the part of the housing in which the bone conduction generator is arranged has a continuous surface that is suitable to be placed at the neck behind the ear or in front of the ear between ear and cheek. The continuous surface enables an easy cleaning of the portable device, e.g. during the cleaning the disinfection agent will not penetrate into the inner of the portable device.

Thereby, in order to increase convenience and usability of the portable device, the electromechanical transducer preferably is decoupled from at least a further part of the housing other than the part of the housing encasing the bone conduction generator.

Preferably, the audio information about the spatially distributed objects can be digitally stored in a non-volatile memory. The non-volatile memory may be integrated in the device, or provided in a host connected with the device via a data communication network. The non-volatile memory can be in any form suitable for digitally storing the information, such as hard disk, solid state disk, flash memory, disk array, network attached disk, or a cloud.

For communicating with the host via a data communication network, the identification receiver can be equipped with a suitable adapter or interface using technologies like wireless local area network (WLAN), or Bluetooth. The audio information can be communicated via broadcast, multicast or unicast, depending on the requirement and network performance. For instance, broadcast or multicast can be used in case the network cannot handle the number of devices simultaneously in use. In an exemplary embodiment, the audio information will be provided via unicast over a WLAN. For instance, once the user activates the paly back of the information about the object, the device will either open the data in the portable device, or connect to the node via the WLAN and find the date file containing the information in digital form. Accessing the audio information provided by a host instead of the portable device has the advantage that the update of the audio information only needs to be performed on the host but not on each of portable devices.

Preferably, the audio information of the spatially distributed objects has an index indicative of relevant parts of the audio information relating to the objects respectively. This enables an accelerated access to the digital data containing the audio information and also the play back of the audio information. Upon identifying an object and activating of the play back, the data file or files having the index indicative of the object will be accessed and played back. The index can for instance refer to the identification of the object. The indexing of the information can be achieved by using a Content Management Software. The Content Management Software can also be used to provide updates of information, e.g. when there is updated audio information for a particular object, there are new objects in place, or the portable device shall be used for a new museum that shows entirely different objects.

Preferably, the controller has a processor configured to retrieve or extract the audio information about the one of the objects identified from the non-volatile memory such as a data storage. The processor can further generate and forward the electrical signals to the bone conduction such that the bone conduction generator provides the mechanical vibrations representing the audio information about the one of the objects.

Preferably, the portable device comprises a bookmark button connected to the controller, wherein the controller is configured to store an electronic bookmark referring to the one of the objects when the bookmark button being activated. When activating the bookmark button, the portable device should be still in the signal reach of the identifier or while still listening the audio information. The bookmark button can include an indicator showing the user that the bookmark can be saved, e.g. if the portable device within the reach covered by the electronic identifier. After storing one or more bookmarks, the user can send the bookmarks at the check-in and -out station. This so-called post-visit-experience can be enabled by the Content Management Software too.

Preferably, the portable device comprises a readiness indicator configured to provide a readiness signal to indicate that the identification receiver received the identification signal. The readiness signal can be an optical signal such as a light or a tactile signal such as a vibration and notifies the user that the information about the object is ready for play back.

Preferably, the controller of the portable device is connected to the readiness or notification indicator and configured to operate the readiness indicator to provide the readiness signal when the identification signal is obtained. In other words, upon receiving the identification signal, the readiness signal notifies the user that the information about the object is ready for play back.

Preferably, the portable device comprises a play button connected to the controller and configured to induce the controller to provide the electrical signals to the bone conduction generator. When the information is ready for play back, the user can activate the play back by pressing the play button. Alternatively, the portable device comprises a capacitive sensor that determines the portable device being placed at the skull around the ear and automatically activates the play back of the information, without pressing the play button. Furthermore, the portable device can also be provided with a pressure sensor that determines the pressure. In this case the play back will only be activated if the pressure exceeds a certain threshold, thereby preventing play back with unintended placement of the portable device at the skull. Either approach for activating the play back enables an easy use in comparison to the conventional devices where several inputs may be required, e.g. at least the identification or location of the object needs to be entered manually and then the play back can be activated.

According to another aspect, the present invention introduces a system for providing a user with information about spatially distributed objects. The system comprises at least one portable device as described above, and a plurality of identifiers each configured to be associated to one of the objects and to send the identification signal identifying the one of the objects.

The identifier can be associated to the respective one of the objects by being positioned in vicinity of this object, in an empty space within this object, or by being mounted to this object. The identification signal can represent a location, a name, a number or a similar identification of the one of the objects.

Preferably, wherein each of the plurality of the identifiers comprises at least one ultra-wideband sender configured to send ultra-wideband signals to the portable device. The ultra-wideband signal sent by one identifier can have a certain reach covering the space around the associated object and can be sent in form of a broadcast message, i.e. a portable device will automatically receive this message when it is within the reach of the ultra-wideband signal. This enables that the portable device is ready for playing back the audio information about an object upon occurring the reach of the identifier, without any user intervention such as manual entering the identification of the object or scan any code placed next to the object.

Preferably, the system comprises a device check station or a kiosk configured to be coupled to the at least one portable device and to provide a service to a user of the at least one portable device. Providing a service to the user of the at least one portable device may comprise at least one of the followings: providing user instructions to the user, setting a language of information, or selecting a predefined tour. This allows the user to configure the portable device by himself according to his need, which improves the user experience. Moreover, the device check station or the kiosk can also evaluate the electronic bookmarks and create a profile for the user based on the electronic bookmarks.

Preferably, the device check station or the kiosk is configured to charge the at least one portable device.

Preferably, the device check station configured to obtain an electronic bookmark from the at least one portable device when the device check station is coupled to the at least one portable device.

Preferably, the device check station is configured to evaluate the electronic bookmark and to generate a data set with respect to the evaluated electronic bookmark. The data set with respect to the evaluated electronic bookmark may comprise information about the object associated to the bookmark. Also, it can involve information about a number of objects associated to a plurality of bookmarks in common. Evaluation of the bookmarks include creating a profile for the user based on the objects he bookmarked during the visit. Generating the data set may refer to creation of the user profile and may also include the provision of a web page accessible at a dedicated URL. The URL can then be forwarded to the user, e.g. per email. The data set enables user to view the information about the bookmarked object after the visit tour.

Preferably, the system comprises a device management arrangement or a docking station configured to be coupled to the at least one portable device and to transfer the information about the objects to which the plurality of identifiers is associated to the at least one portable device. Preferably, the device management arrangement can comprise or be integral with the device check station. This check station can serve as an information management centre that can provide the information to the portable device and send the information to the user, e.g. per email. Moreover, the device management arrangement can also evaluate the electronic bookmarks and create a profile for the user based on the electronic bookmarks.

Preferably, the device management arrangement is configured to charge the at least one portable device.

Preferably, the device management arrangement comprises an operator interface by which the information about the objects to be transferred are definable.

Preferably, the device management arrangement is configured to obtain a bookmark signal from the at least one portable device when the device management arrangement is coupled to the at least one portable device.

Preferably, the device management arrangement is configured to evaluate the bookmark signal and to generate information with respect to the evaluated bookmark signal.

The system according to the present invention improves the overall user experience in easy play back of the information about the object and at the same time managing the information about the objects by bookmarking. With such configured portable device, the user does not need to enter the identification of the object to hear the story and can collect all stories that he is interested in by just pressing the bookmark button.

### BRIEF DESCRIPTION OF THE DRAWINGS

The portable device and the system according to the invention are described in more detail hereinbelow by way of exemplary embodiments and with reference to the attached drawings, in which:

FIG. 1 shows a perspective view of an exemplary embodiment of the portable device according to the present invention;

FIG. 2 shows a front view of the portable device of FIG. 1, wherein some component arranged inside the portable device are schematically depicted;

FIG. 3 shows a front view of the portable device of FIG. 1, wherein a housing of the portable device is open such that some components arranged inside the portable device are visible;

FIG. 4 shows the portable device of FIG. 1 when placed at a skull behind an ear of a user;

FIG. 5 shows a schematic functioning of the bone conduction generator of the portable device of FIG. 1;

FIG. 6 shows a schematic view of an exemplary embodiment of the system according to the invention used in a room of a museum; and

FIG. 7 shows a block diagram illustrating components of the system of FIG. 6.

### DESCRIPTION OF EMBODIMENTS

In the following description certain terms are used for reasons of convenience and are not intended to limit the invention. The terms “right”, “left”, “up”, “down”, “under” and “above” refer to directions in the figures. The terminology comprises the explicitly mentioned terms as well as their derivations and terms with a similar meaning. Also, spatially relative terms, such as “beneath”, “below”, “lower”, “above”, “upper”, “proximal”, “distal”, and the like, may be used to describe one element's or feature's relationship to another element or feature as illustrated in the figures. These spatially relative terms are intended to encompass different positions and orientations of the devices in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. The devices may be otherwise oriented (rotated 90 degrees or at other orientations), and the spatially relative descriptors used herein interpreted accordingly. Likewise, descriptions of movement along and around various axes include various special device positions and orientations.

To avoid repetition in the figures and the descriptions of the various aspects and illustrative embodiments, it should be understood that many features are common to many aspects and embodiments. Omission of an aspect from a description or figure does not imply that the aspect is missing from embodiments that incorporate that aspect. Instead, the aspect may have been omitted for clarity and to avoid prolix description. In this context, the following applies to the rest of this description: If, in order to clarify the drawings, a figure contains reference signs which are not explained in the directly associated part of the description, then it is referred to previous or following description sections. Further, for reason of lucidity, if in a drawing not all features of a part are provided with reference signs it is referred to other drawings showing the same part. Like numbers in two or more figures represent the same or similar elements.

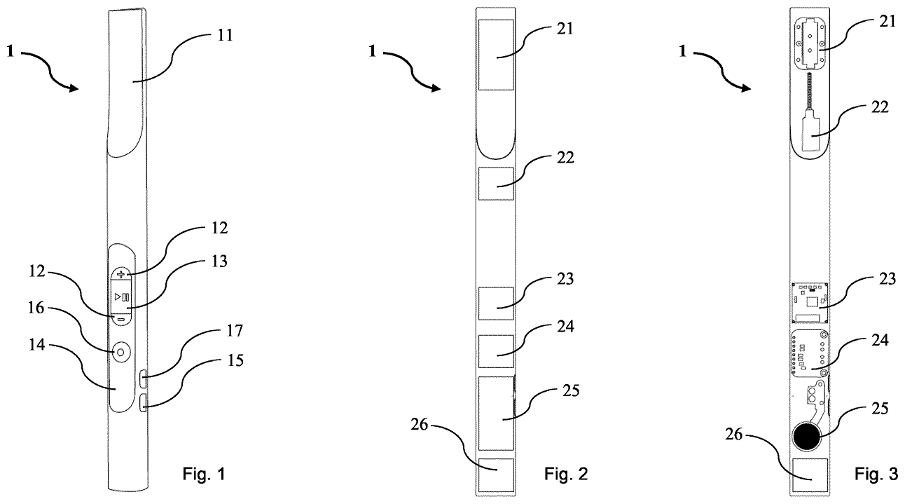

FIG. 1 shows an exemplary embodiment of a portable device 1 according to the present invention. The portable device 1 has an essentially cylindric form with a lowered portion having a surface 11 near a top end. The surface 11 is configured to be placed, e.g., at the neck behind the ear or in front of the ear of a user to contact their skull bone. The portable device 1 has further a play button 13 for activation of play back of the information related to an object identified. The play button 13 is also provided with a pause function to stop the play back. Volume up and down buttons 12 are placed above and below to the play button 13. The portable device 1 further comprises a visual indicator 14 showing the user when information about the identified object is ready for play back, a power button 15 to switch on and off the portable device 1, a bookmark button 16 to bookmark an identified object, and a function button 17. According to the need, the function button 17 can be configured to connect the device portable device 1 with a communication network, to function as the bookmark button, to update the information about the objects with a host, and/or managing services of the portable device 1. The visual indicator 14 may be a light field or point using LED.

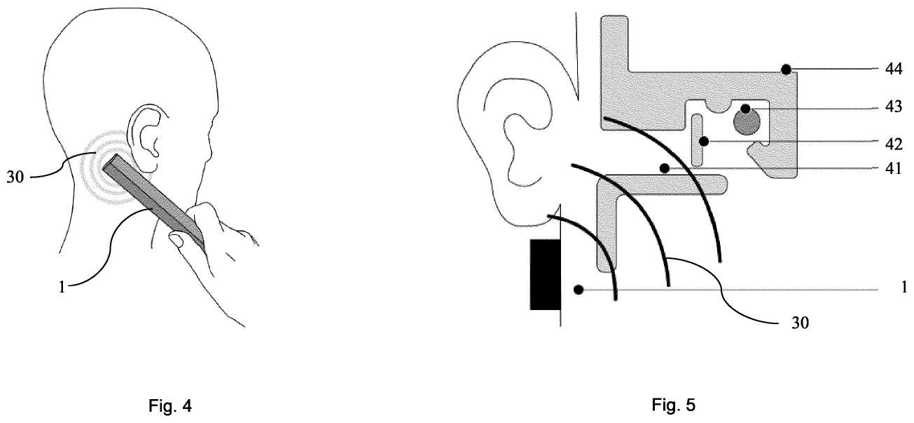

FIGS. 2 and 3 show components inside the portable device 1. Thereby, it can be seen that the portable device 1 is equipped with a power supply including a battery 25 and a charging interface 26. The portable device 1 further comprises an identification receiver 24 acting as a sensor for receiving the identification of an object. The identification receiver 24 comprises an ultra-wideband receiver or sensor for receiving ultra-wideband signals. The portable device 1 further comprises a network interface 23 integrated in the identification receiver 24 for establishing a data communication using wireless LAN and/or Bluetooth technology. The controller 25 has a microcontroller connected to the identification receiver 24. The controller 25 controls the operation of the portable device 1. An operating software and other software applications can be installed in or by the controller 25. A bone conduction generator 22 is arranged in the portable device 1 and completely covered by a housing. It has an electromechanical transducer including a mechanical vibrator 21. The bone conduction generator 22 converts electric signals representing digital audio information and sends these signals to a mechanical vibrator 21 to generate mechanical vibrations.

FIG. 4 shows the portable device 1 being placed at the skull behind an ear of the user upon the user decided to listen to the audio information about the identified object. The portable device 1 generates mechanical vibrations 30 which are transmitted to the skull bone of the user and generate sound. In an advantageous application, the portable device 1 is correspondingly placed at the skull and/or cartilage in front of the ear, i.e., between ear and cheek of the user.

FIG. 5 shows the principle of converting the mechanical vibrations 30 into sound waves. The portable device 1 is placed at the skull, e.g., behind or in front of the ear. The vibration can be transmitted via the skull bones to the auditory canal 41. The latter stimulates the auditory nerve 42, thereby perceiving the sound wave by the cochlea 43.

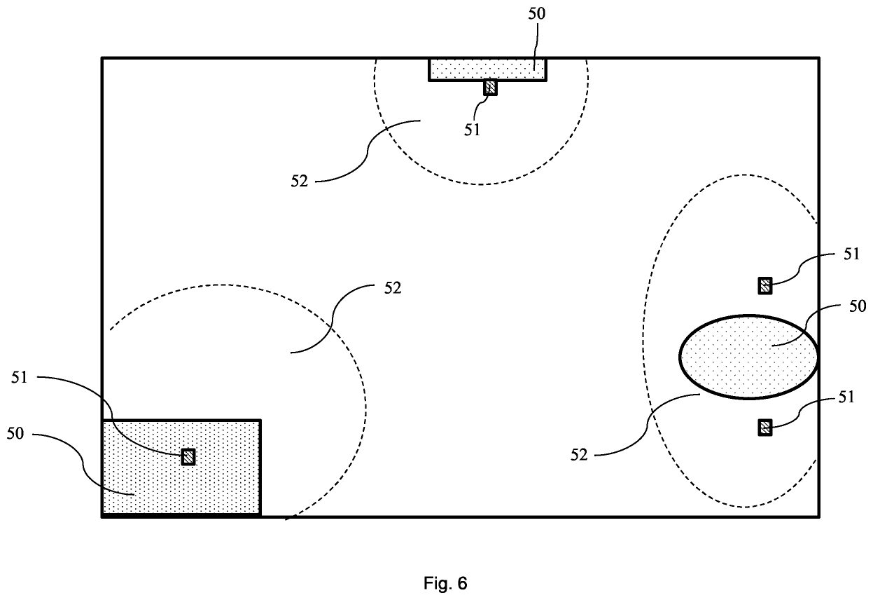

FIG. 6 shows an exemplary embodiment of a system according to the present invention including a plurality of portable devices 1 as described above. The system is used in a room of a museum, where three objects 50 are illustrated. Each object 50 is provided with at least one electronic identifier 51 that is arranged adjacent to the object 50, nearby the object 50 or in the object 50. The electronic identifier 51 has an ultra-wideband sender having a certain signal reach 52. In case of need, two or more identifiers 51 can be provided to one object 50 in order to increase the reach 52 of the identifier, e.g. the object 50 is formed so that one identifier cannot cover the entire area in which the user can view the object 50.

When a user carrying the portable device enters the signal reach 52, i.e. a reachable region 52 of the identifier 51, the identification receiver receives the identification signal from the identifier 51 and notifies the user that a description or story about this object can be played back. When the user moves to another object, the process repeats itself. Within the region 52 that the signal of the identifier 51 can reach, the user can also decide to bookmark the information for the particular object 50 so that he can access to the information later on. The bookmark may also be the identification of an object such as the name or position of the object. Moreover, the system can create a user profile based on the evaluation of his bookmarks. The user profile can include for instance information about what kind of objects are interest by the user, thereby increasing the user experience for the user's next visit. The system improves the overall user experience in easy play back of the information about the object and at the same time in managing the information by bookmarking the information about the objects 50.

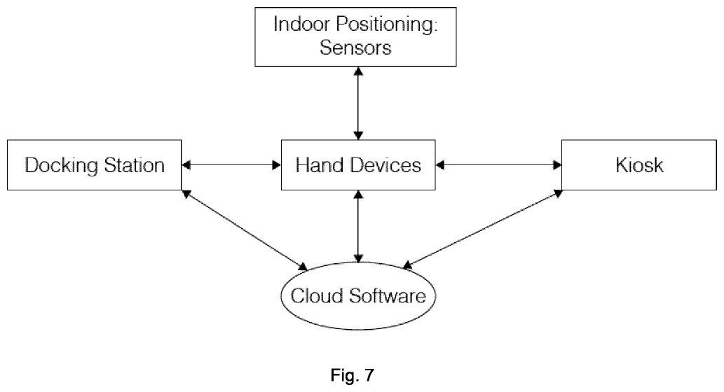

FIG. 7 shows a schematic diagram illustrating the system according to the present invention. For example, when a user of the portable device 1 arrives at a reception of a museum, he can pick up a portable device 1 at a docking station, where a plurality of the portable devices 1 is located. At the same time, the user can also register himself at the docking station so that the portable device is associated with him. The docking station charges the portable devices with electric power such that they are ready for use. The user walks into the museum and stops at an object 50 of interested. Upon receiving the identification signal associated to the object 50, the portable device 1 notifies the user that there is audio information available. The user puts the device at the skull behind or in front of the ear and pushes the play back button 13 such that the audio starts to play back. If he is particularly interested in the specific object 50, the user may press the bookmark button 16 to bookmark the auto information. At the kiosk, e.g. the device check station, the user can charge the portable device 1 or upload the bookmark information using a content management software in the cloud. Alternatively, the upload of the bookmarks can be also done by the provider such as the museum staff or the trade fair staff when the user returns the portable device. In the entire visit the user decides what and when he listens to audio information, without entering any information for preparing the play back. Further, there is no need to write down or scan the identification of an object 50 when he wants to access the information about that object after the visit.

This description and the accompanying drawings that illustrate aspects and embodiments of the present invention should not be taken as limiting the claims defining the protected invention. In other words, while the invention has been illustrated and described in detail in the drawings and foregoing description, such illustration and description are to be considered illustrative or exemplary and not restrictive. Various mechanical, compositional, structural, electrical, and operational changes may be made without departing from the spirit and scope of this description and the claims. In some instances, well-known circuits, structures and techniques have not been shown in detail in order not to obscure the invention. Thus, it will be understood that changes and modifications may be made by those of ordinary skill within the scope and spirit of the following claims. In particular, the present invention covers further embodiments with any combination of features from different embodiments described above and below.

The disclosure also covers all further features shown in the Figs. individually although they may not have been described in the afore or following description. Also, single alternatives of the embodiments described in the figures and the description and single alternatives of features thereof can be disclaimed from the subject matter of the invention or from disclosed subject matter. The disclosure comprises subject matter consisting of the features defined in the claims or the exemplary embodiments as well as subject matter comprising said features.

Furthermore, in the claims the word “comprising” does not exclude other elements or steps, and the indefinite article “a” or “an” does not exclude a plurality. A single unit or step may fulfil the functions of several features recited in the claims. The mere fact that certain measures are recited in mutually different dependent claims does not indicate that a combination of these measures cannot be used to advantage. The terms “essentially”, “about”, “approximately” and the like in connection with an attribute or a value particularly also define exactly the attribute or exactly the value, respectively. The term “about” in the context of a given numerate value or range refers to a value or range that is, e.g., within 20%, within 10%, within 5%, or within 2% of the given value or range. Components described as coupled or connected may be electrically or mechanically directly coupled, or they may be indirectly coupled via one or more intermediate components. Any reference signs in the claims should not be construed as limiting the scope.

1.-35. (canceled)

36. A portable device for providing a user with audio information about spatially distributed objects, comprising:
a bone conduction generator having an electromechanical transducer to convert electrical signals to mechanical vibrations;
an identification receiver configured to receive an identification signal identifying an object of the spatially distributed objects; and
a controller connected to the bone conduction generator and to the identification receiver,
wherein the controller is configured to obtain the identification signal received by the identification receiver and to provide electrical signals to the bone conduction generator such that the bone conduction generator provides mechanical vibrations to generate sound waves representing the audio information about the object of the spatially distributed objects identified by the obtained identification signal.

37. The portable device of claim 36, wherein the identification receiver is configured to receive the identification signal from an identifier associated with the object of the spatially distributed objects when the identification receiver is within a signal reach of the identifier.

38. The portable device of claim 36, wherein the identification signal of the object of the spatially distributed objects represents a position, and/or wherein the identification signal comprises a position of the object of the spatially distributed objects.

39. The portable device of claim 38, wherein the position comprises a proximity between the portable device and the object of the spatially distributed objects.

40. The portable device of claim 38, wherein the controller is configured to evaluate the position of the identification signal to determine proximity between the portable device and the object of the spatially distributed objects, wherein the controller is configured to provide the electrical signals to the bone conduction generator in accordance with the determined proximity.

41. The portable device of claim 36, wherein the identification receiver comprises an ultra-wideband sensor configured to receive ultra-wideband signals, wherein the identification receiver is configured to receive the identification signal embodied as an ultra-wideband signal.

42. The portable device of claim 36, comprising a housing encasing the bone conduction generator, the identification receiver and the controller, wherein at least a part of the housing encasing the bone conduction generator forms an essentially completely tight outer surface, wherein the electromechanical transducer of the bone conduction generator is decoupled from at least a further part of the housing other than the part of the housing encasing the bone conduction generator.

43. The portable device of claim 36, wherein the audio information of the spatially distributed objects has an index indicative of each of the spatially distributed objects.

44. The portable device of claim 36, comprising a non-volatile memory configured to:
digitally store the audio information about the spatially distributed objects, and/or
obtain the audio information digitally stored in a non-volatile memory on a host connected to the portable device via a data communication network.

45. The portable device of claim 44, wherein the controller has a processor configured to extract the audio information about the object of the spatially distributed objects identified from the non-volatile memory, and to generate and forward the electrical signals to the bone conduction such that the bone conduction generator provides the mechanical vibrations representing the audio information about the object of the spatially distributed objects.

46. The portable device of claim 36, comprising a bookmark button connected to the controller, wherein the controller is configured to store an electronic bookmark referring to the object of the spatially distributed objects when being activated.

47. The portable device of claim 36, comprising a readiness indicator configured to provide a readiness signal to indicate that the identification receiver received the identification signal, wherein the controller is connected to the readiness indicator and configured to operate the readiness indicator to provide the readiness signal when the identification signal is obtained.

48. The portable device of claim 36, comprising a play button connected to the controller and configured to induce the controller to provide the electrical signals to the bone conduction generator.

49. The portable device of claim 36, wherein the electromechanical transducer of the bone conduction generator is surrounded by a sound absorbing material.

50. The portable device of claim 36, wherein the device is arranged to contact a head of a user in order to transfer the audio information about the object of the spatially distributed objects by means of sound waves generated by the mechanical vibrations provided by the bone conduction generator, wherein the portable device is shaped to keep an ear canal of the user free while contacting a head of the user.

51. A system for providing a user with audio information about spatially distributed objects, comprising:
at least one portable device according to claim 36; and
a plurality of identifiers each identifier being configured to be associated with a respective object of the spatially distributed objects and to send an identification signal identifying the respective object.

52. The system of claim 51, wherein each identifier of the plurality of the identifiers comprises at least one ultra-wideband sender configured to send ultra-wideband signals.

53. The system of claim 51, comprising a device check station configured to be coupled to the at least one portable device and to provide a service to the user of the at least one portable device, wherein providing a service to the user of the at least one portable device comprises:
providing user instructions to the user;
setting a language of the audio information; and/or
selecting a predefined tour.

54. The system of claim 53, wherein the device check station is configured
to obtain an electronic bookmark from the at least one portable device when the device check station is coupled to the at least one portable device;
to evaluate the electronic bookmark and to generate a data set with respect to the evaluated electronic bookmark; and/or
to evaluate the electronic bookmark and to generate a profile for the user with respect to the evaluated electronic bookmark.

55. The system of claim 54, comprising a device management arrangement configured to be coupled to the at least one portable device and to transfer the information about the spatially distributed objects to which the plurality of identifiers being associated to the at least one portable device, wherein the device management arrangement:
is configured to charge the at least one portable device;
comprises an operator interface by which the audio information about the spatially distributed objects to be transferred are definable;
is configured to obtain the electronic bookmark from the at least one portable device when the device management arrangement is coupled to the at least one portable device; and/or
is configured to evaluate a bookmark signal and to generate a data set with respect to the evaluated bookmark signal.
